(19) United States
(12) Patent Application Publication
(10) Pub. No.: US 2025/0329128 A1
(43) Pub. Date: Oct. 23, 2025

(54) OBJECT DETECTION DEVICE AND OBJECT DETECTION METHOD

(71) Applicant: NIPPON TELEGRAPH AND TELEPHONE CORPORATION, Tokyo (JP)

(72) Inventors: Hiroyuki UZAWA, Tokyo (JP); Saki HATTA, Tokyo (JP); Shuhei YOSHIDA, Tokyo (JP); Yuko IINUMA, Tokyo (JP); Daisuke KOBAYASHI, Tokyo (JP); Yuya OMORI, Tokyo (JP); Yusuke HORISHITA, Tokyo (JP); Ken NAKAMURA, Tokyo (JP)

(73) Assignee: NIPPON TELEGRAPH AND TELEPHONE CORPORATION, Tokyo (JP)

(21) Appl. No.: 18/869,923

(22) PCT Filed: Jun. 7, 2022
(86) PCT No.: PCT/JP2022/022986

§ 371 Date: Nov. 27, 2024

(51) Int. Cl. G06V 10/26; G06T 7/20

(52) U.S. Cl. CPC G06V 10/26; G06T 7/20; G06T 2207/10016; G06T 2207/20081

(57) ABSTRACT

An object detection device that detects an object from an image included in a moving image includes: an acquisition unit configured to acquire the image from the moving image; a number-of-faces setting unit configured to set a number of faces for dividing the image into a plurality of partial faces using a difference between consecutive images; an allocation control unit configured to allocate a frequency of detecting the object for each of the divided partial faces; a division processing unit configured to divide the image into a plurality of partial faces depending on the set number of faces and to detect an object from the partial faces in accordance with the allocated frequency; an overall processing unit configured to reduce the image to an entire face indicating the entire image and to detect an object from the entire face; and a combination processing unit configured to combine respective detection results detected from the partial faces and the entire face to detect an object from the image.

### TECHNICAL FIELD

The disclosed technology relates to an object detection device and an object detection method.

### BACKGROUND ART

A technique for detecting metadata including a position, an attribute, and a reliability of an object included in an input image from an image and detecting an object is disclosed. For example, video processing techniques such as You Only Look Once (YOLO) that detects metadata of an object and Single Shot Multibox (SSD) using deep learning have been disclosed, and application to monitoring cameras, flight control of drones, and the like has been studied.

### CITATION LIST

### Non Patent Literature

Non Patent Literature 1: Joseph Redmon et. al, “YOLOv3: An Incremental Improvement”. <URL: https://arxiv.org/abs/1804.02767>
Non Patent Literature 2: Wei Liu et. al, “SSD: Single Shot MultiBox Detector”. <URL: https://arxiv.org/pdf/1512.02325.pdf>
Non Patent Literature 3: H. Uzawa et. al, “High-definition object detection technology based on AI inference scheme and its implementation”, IEICE Electronics Express, 2021, Volume 18, Issue 22, Pages 20210323.
Non Patent Literature 4: Takayuki Ujiie et al., “Load Mitigation of CNN-Based Object Detection Utilizing Motion Vector in Video Codecs”, Vol. 2018-CVIM-210 No. 4 Technical Report of Information Processing Society of Japan
Non Patent Literature 1 discloses a method of detecting an object from input images of 320×320 pixels, 416×416 pixels, and 608×608 pixels using YOLO.
Non Patent Literature 2 discloses a method of detecting an object using SSD.

Non Patent Literature 3 discloses a method of dividing an input image into a plurality of images, detecting an object through YOLO using a partial surface indicating a part of the input images and an entire surface indicating the entire image by reducing the input image, and combining results detected from the partial surface and the entire surface to obtain a final object detection result.

Non Patent Literature 4 discloses a method of predicting a moving position of each object on the basis of a motion vector and correcting the object position, thereby making it possible to thin out frames for executing object detection.

### SUMMARY OF INVENTION

### Technical Problem

Meanwhile, in a case where an object is detected from an image using a trained model which has been subjected to deep learning, the size of the image to be detected is limited. For example, in a case where processing of detecting an object is performed on an ultra-high definition video such as that of 4K (3840×2160 pixels), detection may be performed using a partial surface obtained by dividing an input image into a plurality of images and an entire surface obtained by reducing the input image. Here, in a case where an input image in an ultra-high definition video is divided into partial surfaces of 608×608 pixels, processing of detecting an object is performed on each of 28 partial surfaces, increasing the processing amount. Therefore, as a method of curbing the processing amount, as described above, partial surfaces for detecting an object are thinned out, and the position of the detection result for the thinned partial surfaces is corrected according to movement prediction of the object, thereby realizing curbing of the processing amount.

However, in a case where the number of partial surfaces on which detection is executable per frame is small and the total number of partial surfaces is large, the number of times of thinning (detection processing is not executed) in each partial surface also increases. Therefore, in a case where a sudden change such as a sudden turn of a drone occurs in a moving image, movement of an object is not accurately predicted, and the object tracking performance may deteriorate.

By reducing the total number of partial surfaces, the number of partial surfaces on which object detection can be executed increases, and thus a range in which an object is detected is expanded in the same frame and object trackability is improved. On the other hand, reducing the total number of partial surfaces involves image reduction on each partial surface, leading to deterioration of object detection performance. That is, in a case where an object is detected from an ultra-high definition video, there is a possibility that both object tracking performance and object detection performance cannot be achieved.

The present disclosure has been made in view of such circumstances, and an object of the present disclosure is to propose an object detection device and an object detection method capable of achieving both object tracking performance and object detection performance in a case where an object is detected from an ultra-high definition video or the like.

### Solution to Problem

A first aspect of the present disclosure is an object detection device that detects an object from an image included in a moving image, the object detection device including: an acquisition unit configured to acquire an image from a moving image; a number-of-surfaces setting unit configured to set a number of surfaces for dividing the image into a plurality of partial surfaces using a difference between consecutive images; an allocation control unit configured to allocate a frequency of detecting an object for each of the partial surfaces after division; a division processing unit configured to divide the image into a plurality of partial surfaces depending on the set number of surfaces and to detect an object from the partial surfaces in accordance with the allocated frequency; an overall processing unit configured to reduce the image to an entire surface indicating the entire image and to detect an object from the entire surface; and a combination processing unit configured to combine respective detection results detected from the partial surfaces and the entire surface to detect an object from the image.

A second aspect of the present disclosure is an object detection method for detecting an object from an image included in a moving image, the object detection method including: acquiring an image from a moving image; setting a number of surfaces for dividing an image into a plurality of partial surfaces using a difference between consecutive images; allocating a frequency of detecting the object for each of the partial surfaces after division; dividing the image into a plurality of partial surfaces depending on the set number of surfaces and detecting an object from the partial surfaces in accordance with the allocated frequency; reducing the image to an entire surface indicating the entire image and detecting an object from the entire surface; and combining respective detection results detected from the partial surfaces and the entire surface to detect an object from the image.

### Advantageous Effects of Invention

According to the disclosed technology, both object tracking performance and object detection performance can be achieved in a case where an object is detected from an ultra-high definition video or the like.

### BRIEF DESCRIPTION OF DRAWINGS

FIG. 1 is a block diagram illustrating a hardware configuration of an object detection device according to the present embodiment.

FIG. 2 is a block diagram illustrating an example of a functional configuration of the object detection device 10 according to the present embodiment.

FIG. 3 is a data flow diagram illustrating an example of a data flow of detection processing provided for describing detection of an object according to the present embodiment.

FIG. 4 is a data flow diagram illustrating an example of a data flow of number-of-surfaces setting processing for describing setting of the number of surfaces according to the present embodiment.

FIG. 5 is a graph showing an example of time-series data of a difference average value and the number of surfaces for describing a guard time according to the present embodiment.

FIG. 6 is a data flow diagram illustrating an example of a data flow of allocation control processing for describing allocation of a detection frequency for each partial surface according to the present embodiment.

FIG. 7 is a flowchart illustrating an example of object detection processing according to the present embodiment.

FIG. 8 is a flowchart illustrating an example of number-of-surfaces setting processing according to the present embodiment.

FIG. 9 is a flowchart illustrating an example of allocation control processing according to the present embodiment.

### DESCRIPTION OF EMBODIMENTS

Hereinafter, exemplary embodiments for carrying out the present disclosure will be described in detail with reference to the drawings.

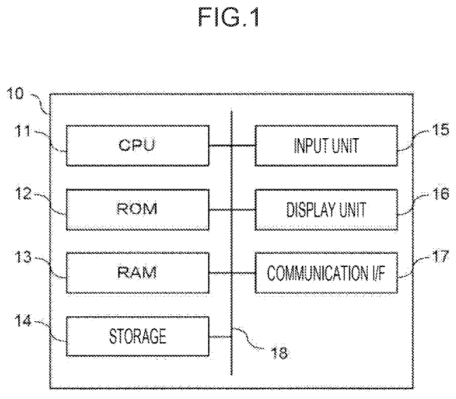

First, a hardware configuration of an object detection device 10 according to the present embodiment will be described with reference to FIG. 1. FIG. 1 is a block diagram illustrating a hardware configuration of the object detection device 10 according to the present embodiment.

As illustrated in FIG. 1, the object detection device 10 includes a central processing unit (CPU) 11, a read only memory (ROM) 12, a random access memory (RAM) 13, a storage 14, an input unit 15, a display unit 16, and a communication interface (I/F) 17. The respective components are connected to each other via a bus 18 such that they can communicate. Note that the above-described configuration using the CPU and the memories is merely an example, and may be implemented as, for example, a device that performs specialized detection of an object equipped with a dedicated arithmetic circuit.

The CPU 11 is a central processing unit that executes various programs and controls each unit. That is, the CPU 11 reads a program from the ROM 12 or the storage 14 and executes the program using the RAM 13 as a work area. The CPU 11 performs control of each of the above-described components and various types of arithmetic processing according to programs stored in the ROM 12 or the storage 14. In the present embodiment, an object detection processing program for detecting an object from an image is stored in the ROM 12 or the storage 14. The ROM 12 stores various programs and various types of data. The RAM 13 is a work area and temporarily stores programs or data. The storage 14 includes a storage device such as a hard disk drive (HDD) or a solid state drive (SSD), and stores various programs including an operating system and various types of data.

The input unit 15 includes a pointing device such as a mouse and a keyboard, and is used to perform various inputs.

The display unit 16 is, for example, a liquid crystal display, and displays various types of information. The display unit 16 may function as the input unit 15 by adopting a touch panel system.

The communication interface 17 is an interface for communicating with other apparatuses such as a display device. For the communication, for example, a wired communication standard such as Ethernet (registered trademark) or FDDI, or a wireless communication standard such as 4G, 5G, or Wi-Fi (registered trademark) is used. The communication interface 17 acquires input data from an external memory and transmits output data to the external memory.

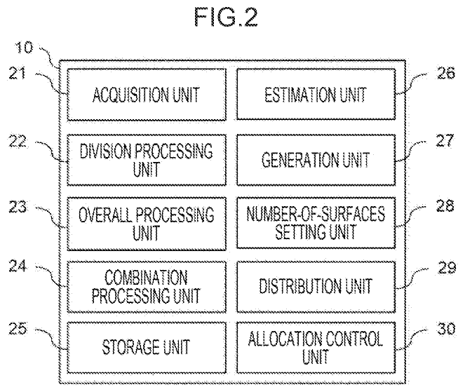

Next, a functional configuration of the object detection device 10 will be described with reference to FIG. 2. FIG. 2 is a block diagram illustrating an example of the functional configuration of the object detection device 10 according to the present embodiment.

As illustrated in FIG. 2, the object detection device 10 includes, as functional components, an acquisition unit 21, a division processing unit 22, an overall processing unit 23, a combination processing unit 24, a storage unit 25, an estimation unit 26, a generation unit 27, a number-of-surfaces setting unit 28, a distribution unit 29, and an allocation control unit 30. The CPU 11 executes an object detection processing program to function as the acquisition unit 21, the division processing unit 22, the overall processing unit 23, the combination processing unit 24, the storage unit 25, the estimation unit 26, the generation unit 27, the number-of-surfaces setting unit 28, the distribution unit 29, and the allocation control unit 30.

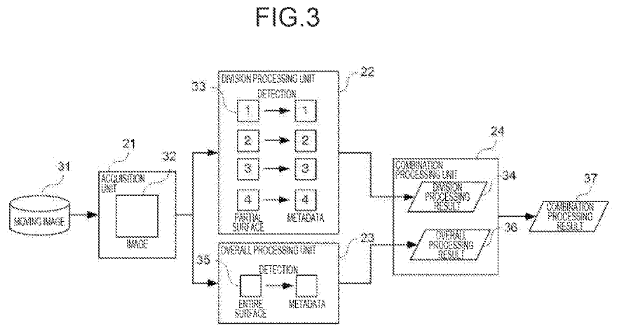

As illustrated in FIG. 3 as an example, the acquisition unit 21 acquires an image 32 for each frame from a moving image 31.

The division processing unit 22 divides the acquired image 32 into images (hereinafter referred to as “partial surface”) 33 of respective portions according to a set number of surfaces, and performs object detection for each of the divided partial surfaces 33 according to an allocated detection frequency. Here, the number of surfaces is set by the number-of-surfaces setting unit 28 which will be described later, and the detection frequency is set by the allocation control unit 30. Note that the division processing unit 22 according to the present embodiment is a learning model obtained by performing machine learning for dividing the image 32 into partial surfaces according to the number of surfaces and detecting an object from each partial surface. The division processing unit 22 detects metadata including the position of an object (the center of the object, and the height and width of a region including the object), attributes of the object, and a reliability indicating the object included in each partial surface 33.

As illustrated in FIG. 3, the division processing unit 22 detects the metadata of the object included in each partial surface 33 and outputs metadata regarding reliabilities of a predetermined size or more as a detection result (hereinafter referred to as a “division processing result”) 34.

The overall processing unit 23 reduces the acquired image 32, detects metadata of an object from an image (hereinafter referred to as an “entire surface”) 35 indicating the entire image and outputs metadata regarding reliabilities of a predetermined size or more as a detection result (hereinafter referred to as an “overall processing result”) 36. Note that the overall processing unit 23 according to the present embodiment is a learning model obtained by performing machine learning for reducing the image 32 to an entire surface and detecting an object from the reduced entire surface.

The combination processing unit 24 combines the division processing result 34 and the overall processing result 36, detects an object from the image 32, and outputs the object. Specifically, as illustrated in FIG. 3, the combination processing unit 24 detects corresponding metadata using the division processing result 34 and the overall processing result 36, and outputs the metadata as a detection result (hereinafter referred to as a “combination processing result”) 37. Furthermore, the combination processing unit 24 detects an object (metadata) that is included in the division processing result 34 and is not included in the overall processing result 36 and outputs the object as the combination processing result 37.

The storage unit 25 stores the acquired image 32 and the division processing result 34. Here, the division processing result 34 is metadata of an object in each partial surface.

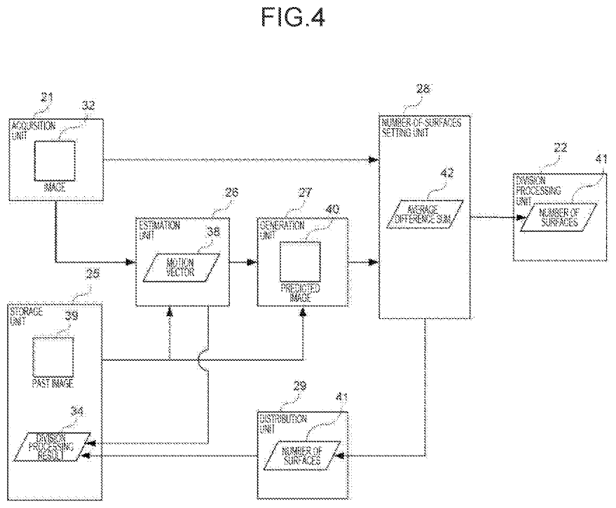

As illustrated in FIG. 4 as an example, the estimation unit 26 performs motion search between the image 32 in the current frame acquired by the acquisition unit 21 and a past image 39 indicating the image of the previous frame stored in the storage unit 25, and estimates a motion vector 38 indicating the movement of the object. As a motion search method, a form using a conventional technique known to those skilled in the art such as a method of comparing the image 32 in the current frame with the past image 39 will be described. However, the motion search method according to the present embodiment is not limited thereto.

As illustrated in FIG. 4, the generation unit 27 generates a predicted image 40 in which the position of the object related to the current frame has been predicted using the past image 39 indicating the image of the previous frame stored in the storage unit 25 and the motion vector 38 estimated by the estimation unit 26.

As illustrated in FIG. 4, the number-of-surfaces setting unit 28 sets the number of surfaces 41 of the partial surfaces 33 using the image 32 indicating the current frame and the predicted image 40 generated by the generation unit 27. Specifically, the number-of-surfaces setting unit 28 derives an absolute difference value of the pixel value in each pixel of the image 32 indicating the current frame and the predicted image 40, and derives the sum (hereinafter referred to as “the sum of absolute difference values”) of the absolute difference values in all the pixels. Here, the sum of absolute difference values according to the present embodiment is represented by the following mathematical formula.

$$[ Math . 1 ]$$

$$diff = {\sum }_{c} {\sum }_{x} {\sum }_{y} \vert I ( N , c , x , y ) - I ( N - 1 , c , x - mvx ( x , y ) , y - mvy ( x , y ) ) \vert \qquad ( 1 )$$

Here, diff is the sum of absolute difference values in all pixels, N is a frame number for identifying a frame, c is the number of channels of an image, x is an x coordinate in the image, and y is a y coordinate in the image. Furthermore, mvx represents an x component of the motion vector 38, and mvy represents a y component of the motion vector 38.

That is, the first term of the above-described formula (1) indicates the pixel values of the image related to the current frame, and the second term indicates the pixel values of the predicted image 40 obtained by correcting the image related to the previous frame using the motion vector 38. The number-of-surfaces setting unit 28 derives absolute difference values between the pixel values of the image related to the current frame and the predicted image 40 corrected by the motion vector 38 for each pixel and channel of the image. The number-of-surfaces setting unit 28 sums the sums of absolute difference values in all pixels and channels to derive the sum of absolute difference values diff for the current frame.

The number-of-surfaces setting unit 28 derives a moving average (hereinafter referred to as “average difference sum”) 42 of the sums of absolute difference values using the derived sum of absolute difference values diff related to the current frame and the sum of absolute difference values diff related to the past frame derived in the past.

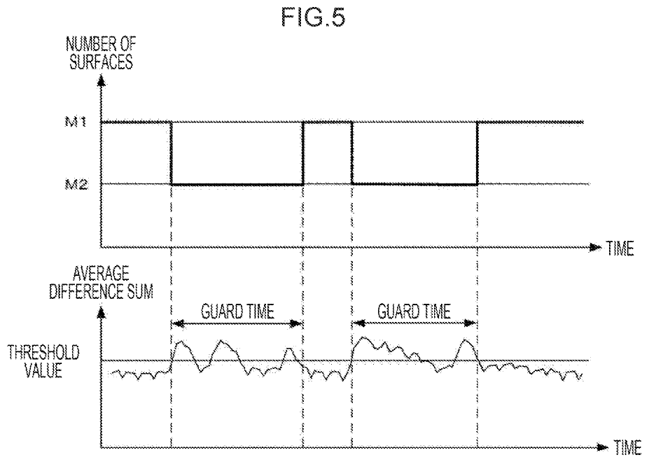

As illustrated in FIG. 4, the number-of-surfaces setting unit 28 sets the number of surfaces 41 depending on the derived average difference sum 42. Specifically, as illustrated in FIG. 5 as an example, in a case where the average difference sum 42 exceeds a predetermined threshold value, the number-of-surfaces setting unit 28 sets the number of surfaces 41 corresponding to the threshold value. For example, as illustrated in FIG. 5, in a case where the average difference sum 42 exceeds the predetermined threshold value, the number-of-surfaces setting unit 28 changes the number of surfaces to M2 less than M1 and sets the number of surfaces as M2. Here, the number-of-surfaces setting unit 28 sets a guard time in advance such that the number of surfaces 41 is not excessively changed, and in a case where the number of surfaces has been changed, does not change the number of surfaces 41 until the guard time elapses regardless of whether or not the average difference sum 42 exceeds the predetermined threshold value. Further, in a case where the guard time has elapsed and the average difference sum 42 is equal to or less than the predetermined threshold value, the number-of-surfaces setting unit 28 changes the number of surfaces 41 to M1 (initial value) and sets the number of surfaces 41 as M1.

That is, in a case where the average difference sum 42 has increased (change in the image is large), the range in which an object is detected is expanded and object tracking performance is improved by decreasing the number of surfaces 41 (increasing each partial surface). In addition, in a case where the average difference sum 42 has decreased (change in the image is small), object detection performance is improved by increasing the number of surfaces 41 (reducing each partial surface).

In the present embodiment, a form in which the threshold value is one has been described. However, the present invention is not limited thereto. The threshold value may be plural. For example, the number-of-surfaces setting unit 28 sets a plurality of predetermined threshold values, and in a case where the average difference sum 42 exceeds threshold values, determines the threshold value having the largest value among the exceeded threshold values, changes the number of surfaces 41 to the number of surfaces 41 corresponding to the determined threshold value, and sets the number of surfaces 41. Note that, in a case where a plurality of threshold values is set, a larger threshold value is associated with a smaller number of surfaces.

The distribution unit 29 distributes the detected objects included in the division processing result 34 stored in the storage unit 25 to the partial surfaces 33 corresponding to the changed number of surfaces 41 according to the changed number of surfaces 41. For example, in a case where the number of surfaces 41 has changed, the partial surface 33 in which the object is detected in the current frame may not correspond to the partial surface 33 in which the object is detected in the past frame. Therefore, as illustrated in FIG. 4, in a case where the number of surfaces 41 has changed, the distribution unit 29 changes the partial surface 33 of the division processing result 34 related to the past frame to the partial surface 33 corresponding to the changed number of surfaces 41, and allocates the position of the detected object to the changed partial surface 33. As a result, even when the number of surfaces 41 has changed, it is possible to compare the partial surface 33 related to the current frame with the partial surface 33 related to the past frame.

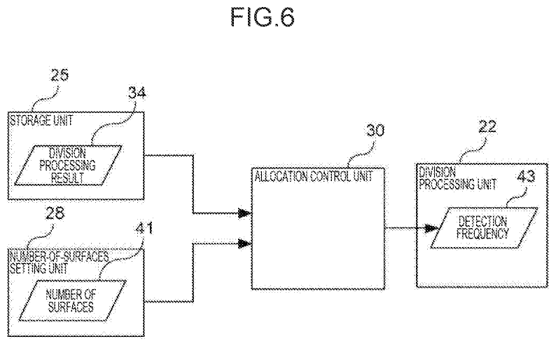

As illustrated in FIG. 6 as an example, the allocation control unit 30 allocates a detection frequency 43 of detecting an object for each partial surface 33 using the division processing result 34 up to the current frame stored in the storage unit 25 and the number of surfaces 41 set by the number-of-surfaces setting unit 28. The allocation control unit 30 sets a period over a plurality of frames in advance, and allocates the detection frequency 43 in the next period for each partial surface 33 using the division processing result 34 in the current period and the number of surfaces 41.

Specifically, the allocation control unit 30 derives a detection number fluctuation value for each period and each partial surface, proportionally distributes an allocatable amount to each partial surface 33 depending on the derived detection number fluctuation value, and allocates the detection frequency 43 in the next period to each partial surface.

Here, the allocatable amount is determined by multiplying the number of frames included in a period by the number of partial surfaces on which predetermined detection is executable. For example, in a case where the number of partial surfaces on which detection is executable per frame is T and the number of frames included in a period is R, the allocatable amount in the period is TxR. Furthermore, in a case where the number of partial surfaces is greater than the number T of partial surfaces on which detection is executable per frame, the partial surfaces on which object detection is executed are narrowed (thinned out) in the division processing unit 22. Therefore, in object detection, the division processing unit 22 applies the motion vector 38 to the division processing result 34 related to the past frame for correction, determines whether or not an object is included in the thinned-out partial surfaces in the current frame, and detects the object. As a result, the processing amount according to detection is reduced.

The detection number fluctuation value according to the present embodiment is represented by the following mathematical formulas.

$$\begin{matrix}[ Math . 2 ] & \\ f ( n ) = {\sum }_{u = 1}^{U} D ( n , k , u ) & ( 2 )\end{matrix}$$

$$\begin{matrix}[ Math . 3 ] & \\ D ( n , k , u ) = \{ \begin{matrix}0 ( In a case in which a partial surface n in a u - th \\ frame is not detected ) \\ \vert d ( n , k , u ) - davg ( n , k - 1 ) \vert ( Other than the above case )\end{matrix} & ( 3 )\end{matrix}$$

Here, f(n) is the detection number fluctuation value, n is a number for identifying a partial surface, u is a number for identifying a frame included in a period, U is a number of frames in a period, D is a detection fluctuation value for each partial surface in each frame, and k is a number for identifying a period. Further, d is the number of detected objects, and davg is an average value (hereinafter referred to as a “detection average value”) of the number of detected objects. For example, in Formula (3) described above, d (n, k, u) indicates the number of objects detected on the partial surface n in the frame u of the current period k. Further, the detection average value avg (n, k−1) indicates a detection average value detected in the past period k−1. The detection average value davg detected up to the current period is updated for each period, and is obtained by averaging the detection average value davg up to the past period and the average value of the number of objects d detected in the current period and used in the next period.

In the present embodiment, a form in which the detection average value davg (n, k) in the current period k and the partial surface n is derived by averaging the detection average value in the current period k and the detection average value davg (n, k−1) up to the past period k−1 has been described. However, the present invention is not limited thereto. Weight values may be multiplied to derive davg in the next period. Specifically, it may be derived as davg=davg (n, k−1)+(1−i) davg (n, k). Here, i is a forgetting coefficient.

The allocation control unit 30 proportionally distributes an allocatable amount to each partial surface 33 such that the detection frequency 43 in the next period increases as the detection number fluctuation value f(n) increases.

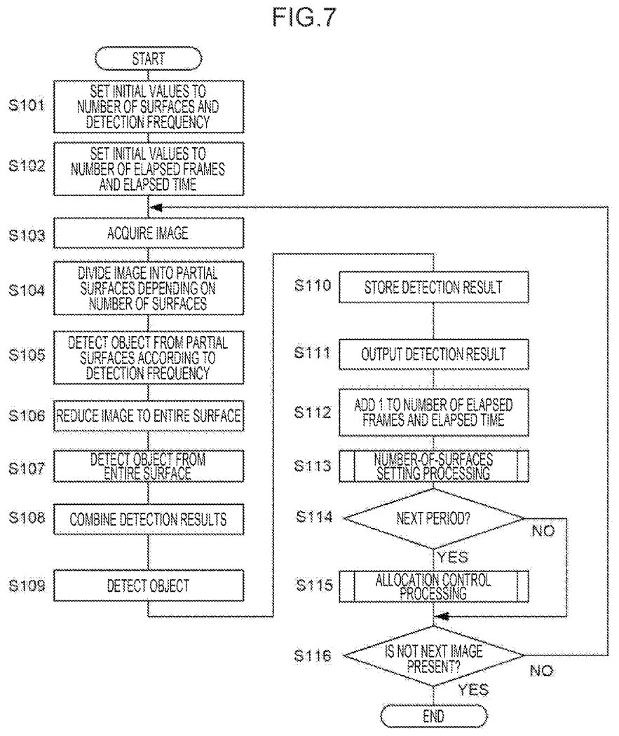

Next, the operation of the object detection device 10 according to the present embodiment will be described with reference to FIG. 7 to FIG. 9. FIG. 7 is a flowchart illustrating an example of object detection processing according to the present embodiment. The CPU 11 reads the object detection program from the ROM 12 or the storage 14 and executes the object detection program, whereby the object detection program illustrated in FIG. 7 is executed. The object detection program illustrated in FIG. 7 is executed, for example, in a case where the moving image 31 is input as input data and an instruction to execute object detection processing is input.

In step S101, the CPU 11 sets initial values for the number of surfaces 41 and the detection frequency 43. For example, the number of surfaces having the largest number of surfaces among numbers of surfaces which can be set as the number of surfaces is set as the number of surfaces 41, and 1 is set for each partial surface as the detection frequency 43.

In step S102, the CPU 11 sets 1 to an elapsed frame and sets 1 to an elapsed time as initial values.

In step S103, the CPU 11 acquires an image 32 for each frame as input data.

In step S104, the CPU 11 divides the image 32 into a plurality of partial surfaces 33 according to the set number of surfaces 41.

In step S105, the CPU 11 detects an object from each partial surface 33 according to the set detection frequency 43. Here, a detection result for a partial surface to be non-thinned is metadata obtained by executing object detection, and a detection result for a partial surface 33 to be thinned is metadata obtained by reading the division processing result 34 in the past frame stored in the storage unit 25 and correcting the position of an object using the motion vector 38 estimated by the estimation unit 26.

In step S106, the CPU 11 reduces the image 32 to the entire surface 35.

In step S107, the CPU 11 detects an object from the reduced entire surface 35.

In step S108, the CPU 11 combines detection results using the division processing result 34 and the overall processing result 36.

In step S109, the CPU 11 detects an object from the combination processing result 37.

In step S110, the CPU 11 stores the image 32 and the division processing result 34.

In step S111, the CPU 11 outputs the combination processing result 37.

In step S112, the CPU 11 adds 1 to the number of elapsed frames and the elapsed time.

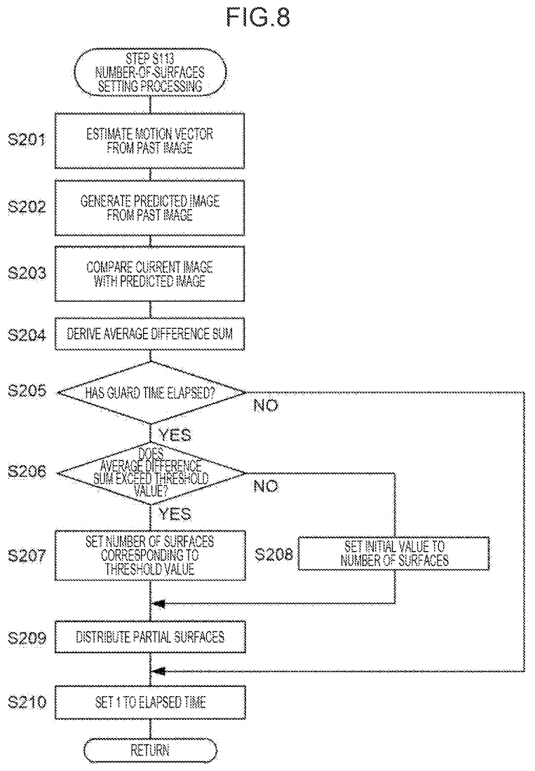

In step S113, the CPU 11 executes number-of-surfaces setting processing. The number-of-surfaces setting processing will be described in detail with reference to FIG. 8 later.

In step S114, the CPU 11 determines whether or not the number of elapsed frames has reached the next period after a predetermined period has elapsed. In a case where the next period has been reached (step S114: YES), the CPU 11 proceeds to step S115. On the other hand, in a case where the next period has not been reached (the number of elapsed frames does not exceed a predetermined period) (step S114: NO), the CPU 11 proceeds to step S116.

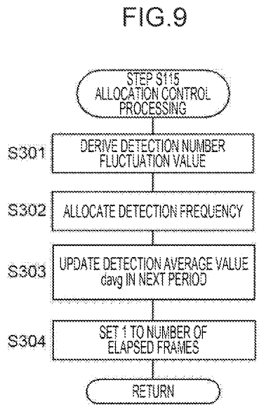

In step S115, the CPU 11 executes allocation control processing. The allocation control processing will be described in detail with reference to FIG. 9 later.

In step S116, the CPU 11 determines whether or not the next image 32 is present. In a case where the next image 32 is not present (step S116: YES), the CPU 11 ends the object detection processing. On the other hand, in a case where the next image 32 is present (step S116: NO), the CPU 11 proceeds to step S103.

Next, the number-of-surfaces setting processing according to the present embodiment will be described with reference to FIG. 8. FIG. 8 is a flowchart illustrating an example of the number-of-surfaces setting processing according to the present embodiment. The CPU 11 reads a number-of-surfaces setting program from the ROM 12 or the storage 14 and executes the number-of-surfaces setting program, whereby the number-of-surfaces setting program illustrated in FIG. 8 is executed. The number-of-surfaces setting program illustrated in FIG. 8 is executed, for example, in a case where the image 32 is input as input data and an instruction to execute the number-of-surfaces setting processing is input.

In step S201, the CPU 11 estimates a motion vector 38 using an acquired image 32 and a past image 39.

In step S202, the CPU 11 applies the estimated motion vector 38 to the past image 39 of the previous frame to generate a predicted image 40.

In step S203, the CPU 11 compares the image 32 according to the current frame with the predicted image 40 to derive the sum of absolute difference values diff.

In step S204, the CPU 11 derives the average difference sum 42 using the derived sum of absolute difference values diff and the past sum of absolute difference values diff.

In step S205, the CPU 11 determines whether or not an elapsed time exceeds a guard time. In a case where the elapsed time exceeds the guard time (step S205: YES), the CPU 11 proceeds to step S206. On the other hand, in a case where the elapsed time does not exceed the guard time (step S205: NO), the CPU 11 proceeds to step S210.

In step S206, the CPU 11 determines whether or not the average difference sum 42 exceeds a predetermined threshold value. In a case where the average difference sum 42 exceeds the predetermined threshold (step S206: YES), the CPU 11 proceeds to step S207. On the other hand, in a case where the average difference sum 42 does not exceed the predetermined threshold value (step S206: NO), the CPU 11 proceeds to step S208.

In step S207, the CPU 11 sets the number of surfaces corresponding to the threshold value. Here, in a case where a plurality of threshold values is set, the number of surfaces corresponding to the threshold value having the largest value among threshold values that the average difference sum 42 exceeds is set.

In step S208, the CPU 11 sets an initial value for the number of surfaces. Here, the number of surfaces having the largest number of surfaces among numbers of surfaces that can be set is set as the initial value.

In step S209, the CPU 11 changes the stored partial surfaces 33 of the division processing result 34 depending on the set number of surfaces 41, and distributes detected objects included in the division processing result 34 to the changed partial surfaces 33.

In step S210, the CPU 11 sets 1 to elapsed time.

Next, allocation control processing according to the present embodiment will be described with reference to FIG. 9. FIG. 9 is a flowchart illustrating an example of the allocation control processing according to the present embodiment. The CPU 11 reads an allocation control program from the ROM 12 or the storage 14 and executes the allocation control program, whereby the allocation control program illustrated in FIG. 9 is executed. The allocation control program illustrated in FIG. 9 is executed, for example, in a case where a predetermined period has elapsed and an instruction to execute the allocation control processing is input.

In step S301, the CPU 11 derives a detection number fluctuation value f(n) using the number of objects detected for each partial surface and the average value of the numbers of object detected in the past periods.

In step S302, the CPU 11 allocates the detection frequency 43 to each partial surface 33 depending on the detection number fluctuation value. Here, the detection frequency 43 allocated to each partial surface 33 is allocated by proportionally distributing an allocatable amount in a period depending on the detection number fluctuation value.

In step S303, the CPU 11 updates the detection average value davg to be used in the next period. Here, the CPU 11 derives the detection average value davg to be used in the next period using the detection average value davg up to the past period and the average value of the numbers of objects d detected in the current period.

In step S305, the CPU 11 sets 1 to the number of elapsed frames.

As described above, according to the present embodiment, in a case where an object is detected from an ultra-high definition video or the like, both object tracking performance and object detection performance can be achieved.

A form in which the detection frequency 43 according to the above embodiment is allocated by proportionally distributing an allocatable amount depending on the detection number fluctuation value has been described. However, the present invention is not limited thereto. For example, 1 may be allocated to the detection frequency 43 of each partial surface 33, and the remaining allocatable amount (allocatable amount-number of surfaces) may be proportionally distributed depending on the detection number fluctuation value.

### Modified Examples

In the above embodiments, a form in which the number of surfaces 41 is changed and set when the predetermined guard time has elapsed has been described. In the present modified example, a form in which the guard time changes will be described.

For example, the object detection device 10 may count the number of changes of the number of surfaces 41 occurring in a predetermined period, and in a case where the number of changes exceeds a predetermined number, extend the guard time by adding a predetermined time to the guard time. This curbs frequent changes in the number of surfaces 41.

Inference processing executed by the CPU reading software (program) in each of the above embodiments may be executed by various processors other than the CPU. Examples of a processor in this case include a programmable logic device (PLD) in which a circuit configuration can be changed after manufacturing, such as a field-programmable gate array (FPGA), a dedicated electric circuit that is a processor having a circuit configuration exclusively designed to execute specific processing, such as an application specific integrated circuit (ASIC), and the like. Furthermore, the object detection processing may be executed by one of these various processors, or may be executed by a combination of two or more processors of the same type or different types (for example, a plurality of FPGAs, a combination of a CPU and an FPGA, or the like). More specifically, the hardware structures of these various processors are electric circuits in which circuit elements such as semiconductor elements are combined.

Further, although an aspect in which the object detection processing program is stored (installed) in advance in the storage 14 has been described in each of the above embodiments, the present invention is not limited thereto. The program may be provided in a form stored in a non-transitory storage medium such as a compact disk read only memory (CD-ROM), a digital versatile disk read only memory (DVD-ROM), or a Universal Serial Bus (USB) memory. In addition, the program may be downloaded from an external device via a network.

With regard to above embodiments, the following supplements are further disclosed.

### (Supplementary Note 1)

An object detection device including:
a memory; and
at least one processor connected to the memory, wherein the processor is an object detection device that detects an object from an image included in a moving image and is configured:
to acquire the image from the moving image;
to set a number of surfaces for dividing the image into a plurality of partial surfaces using a difference between consecutive images;
to allocate a frequency of detecting the object to each of the divided partial surfaces;
to divide the image into a plurality of partial surfaces depending on the set number of surfaces and detect an object from the partial surfaces in accordance with the allocated frequency;
to reduce the image to an entire surface indicating the entire image and detect an object from the entire surface; and
to combine respective detection results detected from the partial surfaces and the entire surface to detect an object from the image.

### (Supplementary Note 2)

A non-transitory storage medium storing a program executable by a computer to execute object detection processing, wherein the object detection processing for detecting an object from an image included in a moving image includes:
acquiring the image from the moving image;
setting a number of surfaces for dividing the image into a plurality of partial surfaces using a difference between consecutive images;
allocating a frequency of detecting the object to each of the divided partial surfaces;
dividing the image into a plurality of partial surfaces depending on the set number of surfaces and detecting an object from the partial surfaces in accordance with the allocated frequency;
reducing the image to an entire surface indicating the entire image and detecting an object from the entire surface; and
combining respective detection results detected from the partial surfaces and the entire surface to detect an object from the image.

### REFERENCE SIGNS LIST

10 Object detection device
21 Acquisition unit
22 Division processing unit
23 Overall processing unit
24 Combination processing unit
25 Storage unit
26 Estimation unit
27 Generation unit
28 Number-of-surfaces setting unit
29 Distribution unit
30 Allocation control unit

1. An object detection device that detects an object from an image included in a moving image, the object detection device comprising:
a memory; and
at least one processor coupled to the memory, the at least one processor being configured to:
acquire the image from the moving image;
set a number of surfaces for dividing the image into a plurality of partial surfaces using a difference between consecutive images;
allocate a frequency of detecting the object for each of the divided partial surfaces;
divide the image into a plurality of partial surfaces depending on the set number of surfaces and to detect an object from the partial surfaces in accordance with the allocated frequency;
reduce the image to an entire surface indicating the entire image and the detect an object from the entire surface; and
combine respective detection results detected from the partial surfaces and the entire surface to detect an object from the image.

2. The object detection device according to claim 1, wherein the at least one processor is further configured to:
estimate a vector indicating movement of an object from the image; and
generate a predicted image in which a current position of the object has been predicted using the vector,
wherein, in a case in which a sum of absolute difference values calculated using the predicted image and the acquired image satisfies a predetermined condition, the at least one processor resets the number of surfaces to a number of surfaces corresponding to the predetermined condition.

3. The object detection device according to claim 2, wherein, in a case in which the predetermined condition is satisfied after a predetermined period has elapsed since setting the number of surfaces, the at least one processor resets the number of surfaces.

4. The object detection device according to claim 3, wherein the at least one processor adds a predetermined time to the predetermined period in a case in which a number of changes of the number of surfaces exceeds a predetermined number of times.

5. The object detection device according to claim 1, wherein the at least one processor sets a period including a plurality of images, and allocates the frequency in a next period for each of the partial surfaces on the basis of a difference between a number of detected objects in a current period and an average value of numbers of detections detected up until the current period.

6. The object detection device according to claim 5, wherein the at least one processor derives the average value of the numbers of detections detected up until the current period using an average value of numbers of detections in the current period and an average value of numbers of detections in a past period.

7. The object detection device according to claim 6, wherein the at least one processor derives the average value of the numbers of detections detected up until the current period using a value obtained by multiplying the average value of the numbers of detections in the current period by a weight value.

8. An object detection method for detecting an object from an image included in a moving image, the object detection method comprising causing a computer to execute processing comprising:
acquiring the image from the moving image;
setting a number of surfaces for dividing the image into a plurality of partial surfaces using a difference between consecutive images;
allocating a frequency of detecting the object for each of the divided partial surfaces;
dividing the image into a plurality of partial surfaces depending on the set number of surfaces and detecting an object from the partial surfaces in accordance with the allocated frequency;
reducing the image to an entire surface indicating the entire image and detecting an object from the entire surface; and
combining respective detection results detected from the partial surfaces and the entire surface to detect an object from the image.
